(19) United States
(12) Patent Application Publication
(10) Pub. No.: US 2024/0302818 A1
(43) Pub. Date: Sep. 12, 2024

(54) SYSTEMS AND METHODS OF AUTO-TERMINATION AND DYNAMIC DRIVE ADJUSTMENT OF POOL OR SPA AUTOMATION NETWORKS INCLUDING MULTIPLE POOL OR SPA EQUIPMENT ITEMS

(71) Applicant: ZODIAC POOL SYSTEMS LLC, Carlsbad, CA (US)

(72) Inventors: Minas Minassian, Carlsbad, CA (US); Eusebio Domingo Bareng, Carlsbad, CA (US)

(73) Assignee: ZODIAC POOL SYSTEMS LLC, Carlsbad, CA (US)

(21) Appl. No.: 18/594,600

(22) Filed: Mar. 4, 2024

Related U.S. Application Data
(60) Provisional application No. 63/450,277, filed on Mar. 6, 2023.

(51) Int. Cl. G05B 19/4155

(52) U.S. Cl. CPC G05B 19/4155; G05B 2219/37371

(57) ABSTRACT

Systems and methods for automatically terminating a network comprising: conducting a first termination test using a first termination resistor associated with a first pool or spa equipment item of a plurality of pool or spa equipment items; conducting a second termination test using a second termination resistor associated with a second pool or spa equipment item of the plurality of pool or spa equipment items; and instructing the first pool or spa equipment item to turn on the first termination resistor based at least in part on a comparison of first performance data associated with the first termination test and second performance data associated with the second termination test, wherein turning on the first termination resistor terminates the first pool or spa equipment item.

### CROSS-REFERENCE TO RELATED APPLICATION

The present patent application claims of the benefit of U.S. Patent Application No. 63/450,277 titled “AUTO TERMINATION AND DYNAMIC DRIVE ADJUSTMENT OF POOL OR SPA AUTOMATION NETWORKS INCLUDING MULTIPLE POOL OR SPA EQUIPMENT ITEMS” filed Mar. 6, 2023, the entire contents of which are incorporated by reference herein for all purposes.

### FIELD

The present disclosure generally relates to terminating networks of devices and more particularly, to systems and techniques for automatically terminating a network of pool and spa equipment items.

### BACKGROUND

Conventional pool automation systems may include a controller electrically connected to multiple items of pool equipment (e.g., pumps, heaters, chlorinators, lighting) to form a network of pool equipment These networks are generally installed by individuals who lack an understanding of network topologies, communication standards, and how the choices made during installation may negatively impact network performance. Each pool or spa may include different configurations of pool equipment and devices, which further complicates an individual's ability to efficiently construct networks. In said networks relying on communication buses under RS-485 standards, improper installation of pool equipment and devices may result in improper termination of the network. Improper termination (e.g., terminating an item of pool equipment nearest to the automation controller) may impact overall performance of the system, leading to signal integrity issues, communication delays or failure.

### BRIEF DESCRIPTION OF THE DRAWINGS

A full and enabling disclosure is set forth more particularly in the remainder of the specification. The specification makes reference to the following appended figures.

FIG. 1 illustrates an example auto-terminating communication network.

FIG. 2 illustrates examples of network topologies for the arrangement of network devices.

FIG. 3 illustrates an example block diagram of an auto-terminating network device between network devices.

FIG. 4 illustrates an example block diagram of an auto-terminating network devices as implemented in pool or spa equipment.

FIG. 5 illustrates a flow diagram for a first method for auto-terminating network devices.

FIG. 6 illustrates a flow diagram for a second method for auto-terminating network devices.

FIG. 7 illustrates a flow diagram for a method for auto-terminating network devices using variable termination resistors.

FIG. 8 illustrates a flow diagram for a method of auto-terminating network devices by activating multiple termination resistors.

FIG. 9 illustrates a flow diagram for a method of dynamically adjusting drive current of a controller.

FIG. 10 illustrates an exemplary computer system for auto-terminating network devices.

### DETAILED DESCRIPTION

In the following description, for the purposes of explanation, specific details are set forth to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs. Further, use of the terms “auto-terminating”, “automatic termination”, and “automatically terminating” are used interchangeably to describe techniques of ending a transmission line of a network by causing, through electrical, electro-mechanical, or mechanical means, a termination resistor to be activated (e.g., switched on) at a device (e.g., item of pool or spa equipment) on the network.

Examples described herein relate to systems, devices, and techniques for auto terminating a network deployed in a spa or pool system (referred to herein as “spa or pool system” or just a “pool system”). The network may use a communication bus such as an RS-485 bus to enable communications between a pool automation controller and various items of connected equipment. Terminating or otherwise balancing the network may include terminating end points in the network, which at one end may be the pool automation controller and at the other end may be one item of connected equipment. In some examples, terminating end points in the network may include two pieces of connected equipment, rather than the pool automation controller and one item of connected equipment. The techniques described herein may further be used to pick which two end points in the network meet a performance metric, such as a network speed.

Pool and spa equipment installers often lack an in depth understanding of proper structuring of items of pool equipment within the network of devices. To simplify installation of pool automation systems, however, is not dictated to system installers, nor are installers required to have an in-depth understanding of the ideal implementation. This gives installers freedom to configure the network in the way that is most suitable for the particular location, including having installers identify terminating equipment in an ad-hoc manner. In some examples, the network may be unterminated. These approaches, however, may lead to systems that are improperly terminated, resulting in performance problems including signal integrity issue, communication delays or failure.

Generally, the techniques described herein relate to a process for automatically identifying the item or items of connected equipment and once identified, electronically “switching in” a termination resistor at the item of connected equipment. Each item of connected equipment and the automation controller may include an electronic circuit capable of switching in and switching out a termination resistor. The process may further include iteratively switching in and switching out the respective termination resistors, running speed tests that identify top network speeds before some failure condition is present, identifying which equipment with a switched in termination resistor resulted in the best speed test, and permanently switching in that termination resistor and switching out the other termination resistors. The speed test can also be used to identify a top data rate for the network. The configuration of the termination resistors in the network can be periodically reevaluated using this same process. Reasons for such a reevaluation may include when a new item of equipment is added, a certain amount of time has passed, items of equipment being relocated, changes to wire quality (e.g., degradation from rodents, roots, water intrusion), and any other event or action that changes the conditions that were present previously.

In some examples, the techniques described herein may cycle through potential pairs of terminating items of equipment in the network. Each potential pair may include at least one item of equipment and the automation controller or a different item of equipment. This may be beneficial for scenarios in which terminating two items of equipment will result in a better performance than terminating one item of equipment and the automation controller. The above methods can be implemented as computer-executable program instructions stored in a non-transitory, tangible computer-readable medium or media and/or operating within a processor or other processing device and memory.

In a further example, the techniques described herein may include a dynamic current drive adjustment technique. In particular, the dynamic current drive adjustment technique may be used to dynamically adjust the RS-485 transceiver current drive capability in the automation controller when a predetermined number of connected pieces of equipment is exceeded. Since each piece of equipment loads the network, this mechanism would help fine tune the current drive capability to maintain an adequate differential voltage on the differential lines. The dynamic current drive adjustment technique may be used in connection with the auto termination technique described herein. Use of the dynamic current drive adjustment technique would complement the auto termination technique to further improve network health. To implement the dynamic current drive adjustment technique may include adding electronic means to vary resistors at the controller node to increase and decrease the drive current.

### Example Auto-Terminating Communication Network

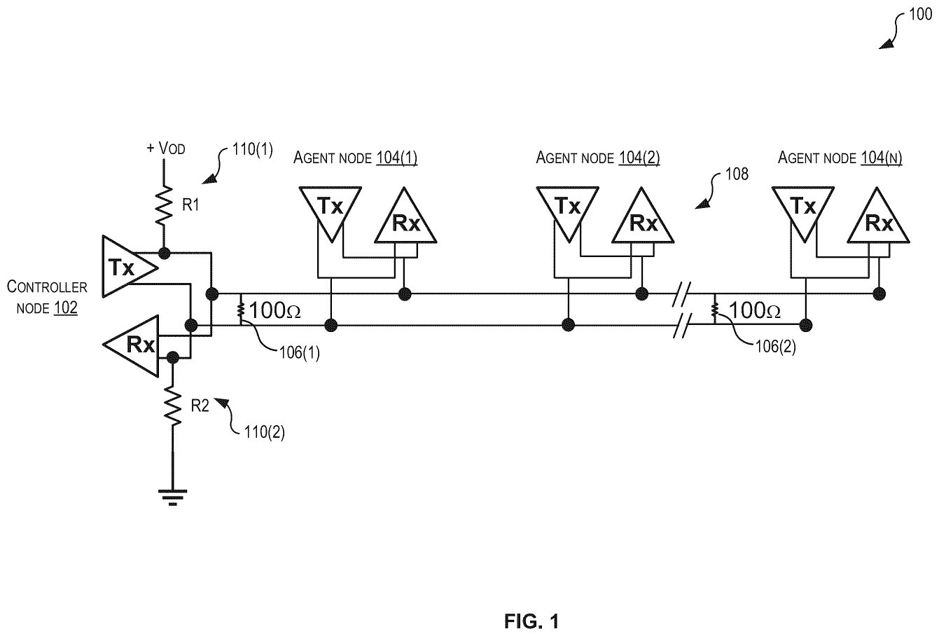

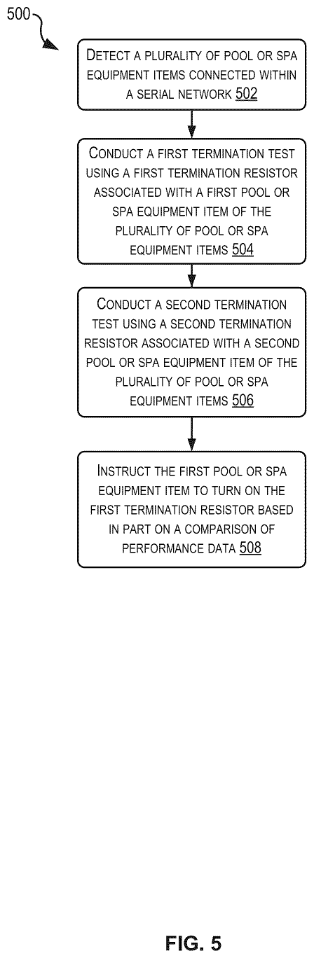

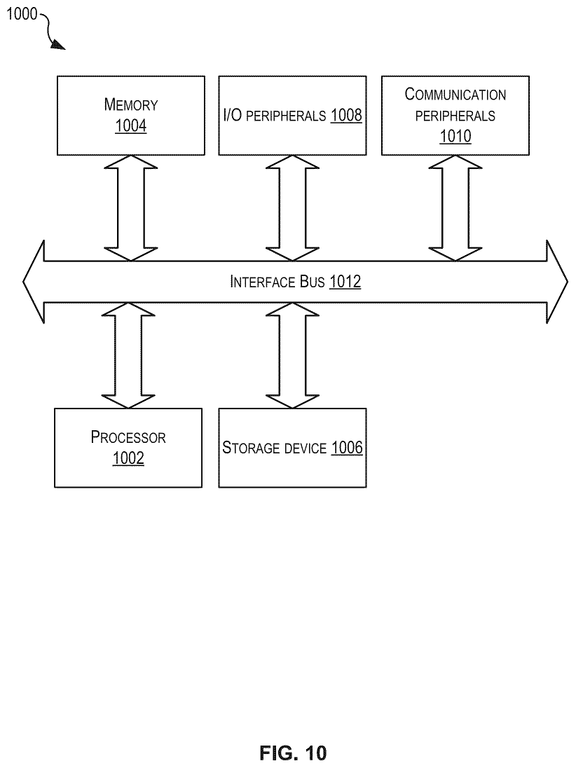

FIG. 1 is an example auto-terminating communication network 100. By way of example, the auto-terminating communication network 100 is implemented on a bus 108. In some examples, the bus 108 may be any bus suitable for a serial communication standard such as, for example, RS-485, RS-422, CAN Bus, or any other suitable standard. As such, the techniques described herein may implement the auto-terminating communication network 100 using any of these serial communication standards. The communication network 100 may include a controller node 102 electrically connected via the bus 108 to a plurality of agent nodes 104(1), 104(2), 104(n). The controller node 102 is an example of a controller described herein. The controller node 102 may include a non-transitory computer-readable medium storing computer-executable program instructions and one or more processors communicatively coupled to the non-transitory computer-readable medium to execute the computer-executable program instructions. Example computer-executable program instructions may include instructions to perform operations such as the operations described in the descriptions of flowcharts for FIGS. 5-9. The controller node 102 may be communicatively connected to one or more agent nodes 104(n) by the serial bus. Further description of an example controller node 102 is provided in the description of FIG. 10.

The agent nodes 104 are examples of the connected pool or spa equipment items described herein. The bus 108 also includes resistors 110(1) and 110(2). In some examples, resistors 110(1) and 110(2) may be part of the agent nodes 104.

As noted, the communication network 100 may include any suitable number of agent nodes 104, including more or fewer than illustrated. The communication network 100 may represent a linear bus topology, extending between the controller node 102 and the agent node 104(n). The communication network 100 also includes a first termination resistor 106(1) at the controller node 102 and a second termination resistor 106(2) at the agent node 104(n). In the linear topology illustrated, the second termination resistor 106(2) may be located at the “end” of the linear chain, e.g., a furthest distance from the controller node 102 along the bus 108. Thus, the communication network 100 illustrates a properly terminated implementation of the bus 108. In this example, the termination resistors 106 are each 100 ohms. The impedance value of the termination resistors may be selected by the controller node 102 based on the network characteristic impedance. When properly terminated, the communication network 100 may function over long distances (e.g., 4000 feet or more), or when the connections between the bus 108 and the agent nodes 104 are relatively short (e.g., less than 250 feet).

The communication network 100 may implement the dynamic current drive adjustment technique described herein. For example, electronic means in the communication network 100 may vary the value of the resistors 110 based on the load on the communications network 100 from the equipment at the agent nodes 104 to maintain an adequate differential voltage on the differential lines of the bus 108.

### Example Network Topologies

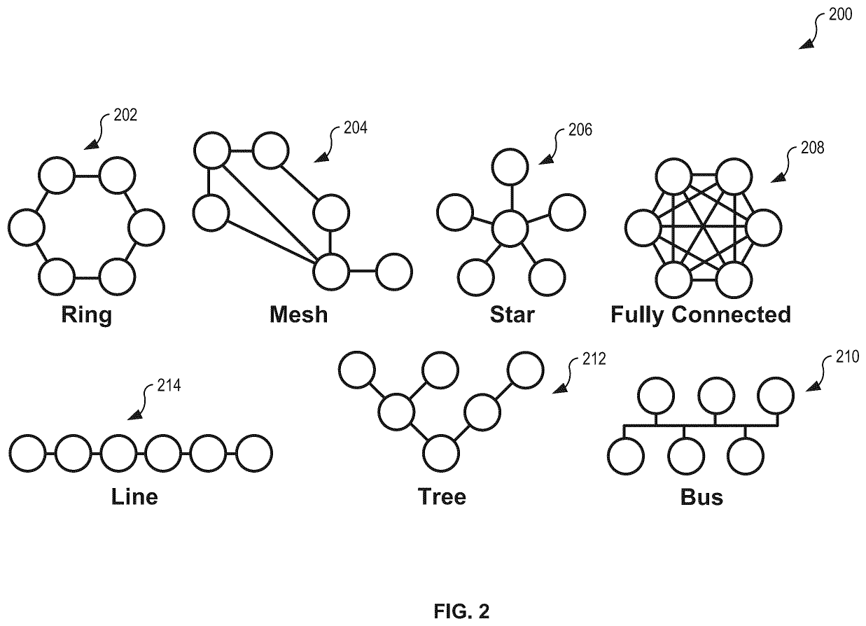

FIG. 2 illustrates a block diagram 200 depicting example network topologies 202-214, which represent example arrangements of nodes within a network configured for auto-termination techniques described herein. Network topologies 202-214 are intended as non-limiting examples. Other arrangements with fewer or more nodes may also allow for auto-termination techniques described herein. Controllers, such as a controller node 102 from FIG. 1, implementing the techniques described herein may identify which of the plurality of agent nodes should be terminated. Network topologies 202-214 may include a controller node and a plurality of agent nodes. Controllers performing these techniques may perform auto-termination regardless of the specific network topology or where the controller node is placed with respect to the topology. In other words, the controller node, for network topologies 202-214, may be any one of the respective nodes. The network topologies 202-214 may represent example topologies that may be created as installers set up a pool or spa system. For example, the specific constraints of the environment in which the system is installed may require a particular topology. Similarly, changes to the system over time may change the topology. This has the added benefit of not requiring installers to understand the network topologies they are constructing so long as the nodes are connected by a bus or to another node in the network. Further, this allows installers to merely add a device to the network without having to consider whether the installation of a device at a given point in the network will cause improper termination of the network.

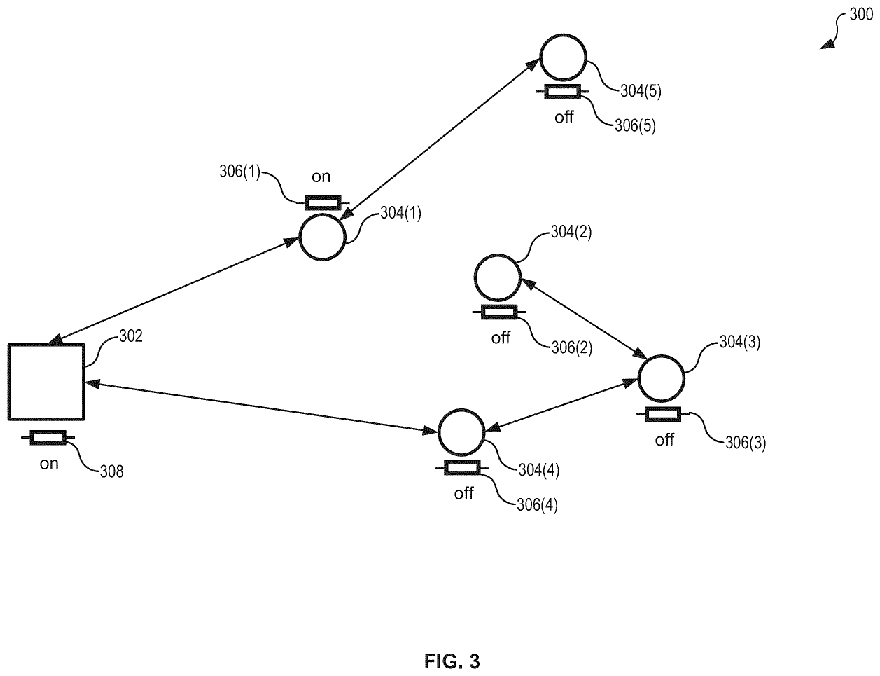

In some examples, the topology of a particular pool or spa system may correspond to a combination of topologies referenced herein. For example, a topology may begin as a bus topology 210, but a later node may be connected directly to an existing node connected to the bus. This can lead to topologies of arbitrary design and layout. For example, FIG. 3 illustrates such a topology.

### Example Network of Nodes

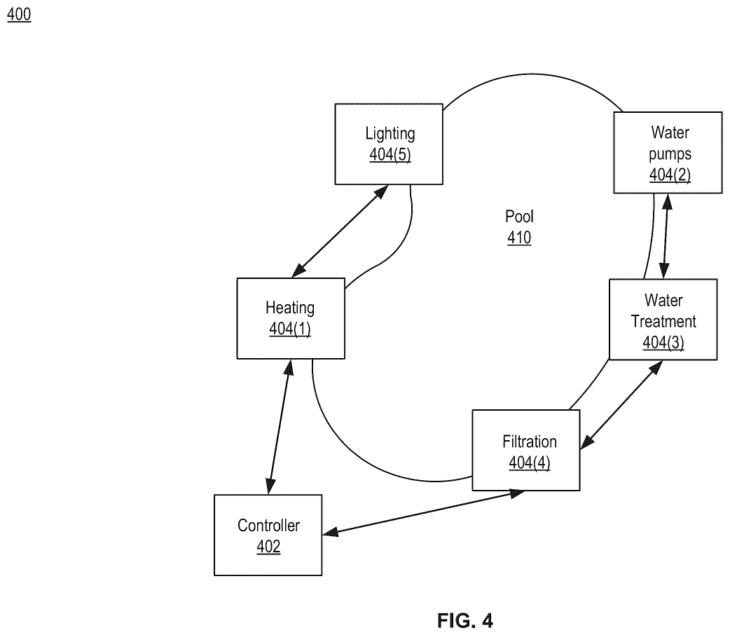

FIG. 3 illustrates network 300 including a controller node 302 (e.g., an automation controller) and a plurality of agent nodes 304(1)-304(5) (e.g., pool or spa equipment as further described in FIG. 4), according to at least one example. The network 300 is an example of the communication network 100 in that the plurality of agent nodes 304 may communicate with controller node 302 via a communication bus such as an RS-485 (e.g., represented by the connecting lines between the nodes). The controller node 302 may include a controller terminating circuit and resistor (CTCR) 308. Each agent node 304 may also include an agent terminating circuit and resistor (ATCR) 306(1)-306(5). In some examples, the CTCR 308 and each ATCR 306 may include a resistor and a terminating circuit for turning the resistor “on” at the respective node. Thus, the terminating circuit may include a switch or other functionality for introducing the resistor at the respective node. In some examples, each terminating circuit may process controls signals from the controller node 302 to turn on and turn off the resistor. The terminating resistor may be located at the plurality of agent nodes 304(1)-304(5) or may be part of the agent nodes (e.g., the agent nodes may connect to a communication bus by a termination resistor being a piece of circuitry of the agent node).

In some examples, the CTCR 308 and each ATCR 306 may be the same circuit and include a resistor having the same value. In some examples, at least one of the circuits and resistors may be different. For example, the CTCR 308 may, in some examples, not include a terminating circuit as the CTCR 308 may be permanently or otherwise hard-wired into the controller node 302. In some examples, the resistors of the ATCRs 306 may be capable of providing a range of varied resistances. For example, a low range, medium range, and high range of resistance values may be used. In some examples, the ATCRs 306 or CTCR may finely tune resistance values of each resistor and the ATCRs 306 or CTCR may have electronic control to adjust the resistance value to a specific value within a range of values. Termination resistors may therefore be variable resistors with multiple resistance states, the resistance states adjustable by the controller. By way of a non-limiting example, termination resistors may be a digital resistor, rheostat resistor, and potentiometer.

As shown in FIG. 3, each resistor at each of the ATCRs 306 and the CTCR 308 may be changed between states of on or off. Using the techniques described herein, the CTCR 308 and a single ATCR 306 may be turned on by the controller node 302 and the controller node 302 may perform a speed test. For example, as illustrated in FIG. 3, the resistor at the CTCR 308 is turned “on” and the resistor at the ATCR 306(1) of the agent node 304(1) is turned “on”. With the network 300 in this state, the controller node 302 may run a speed test (e.g., a benchmarking test or performance test) in which the controller node 302 slowly increases the data rate on the network 300 until a failure condition occurs. For example, the failure condition may depend on data packet error such that when the data packet error exceeds some threshold amount, the failure condition is said to have occurred. The controller may log performance data of the network, such as data rate at which the failure condition occurred along with the identified resistor of 306(1), by storing the performance data in a matrix, spreadsheet, or other table of values. At this point, the controller node 302 may turn off the resistor at the ATCR 306(1) and turn on the resistor at the ATCR 306(2). With this setup, the controller node 302 may perform another speed test to failure. The controller may repeat this process sequentially for each of the remaining agent nodes 304 and corresponding ATCRs 306. Once performance data has been generated for each configuration of the network 300, the controller node 302 may use the performance data to identify which agent node 304 should be set as the “terminating node” for the network 300. For example, this may be the agent node 304 that, when its ATCR 306 turned on, achieved the highest data rate during its speed test. The data rate of this speed test may set the maximum data rate for the network 300, and the identified agent node 304 may be identified as the optimal terminating node. The controller node 302 may then send a signal to the selected ATCR 306 to “permanently” turn on the resistor. The controller node 302 may also set its system data rate to the maximum data rate identified.

In some examples, speed tests may be performed with the resistor at the CTCR 308 turned off and two resistors at two ATCRs 306 turned on. Resistors at different sets of ATCRs 306 may be turned on and turned off, either in combination with the CTCR 308 or not, to identify the best pair of terminating nodes in the network 300. In this example, the best pair of terminating nodes may be selected as the pair of nodes that achieved the highest data rate during its respective speed test, as described herein.

### Example Network of Nodes Implemented in a Pool

FIG. 4 illustrates the network topology as FIG. 3, as applied to a pool or spa, however like FIG. 3, the network may be arranged in various other configurations, such as any of the network topologies illustrated or described in FIG. 2. FIG. 4 includes a pool or spa network 400 including a controller 402 (e.g., an automation controller) and a plurality of items of pool equipment 404(1)-404(5) installed at a pool 410. By way of a non-limiting example, the items of pool equipment may include water heating equipment 404(1), water pumps 404(2), water treatment equipment 404(3), filtration equipment 404(4), and lighting equipment 404(5). Other pool or spa equipment may be added to the network such as additional water treatment equipment, an automatic pool cover, etc.

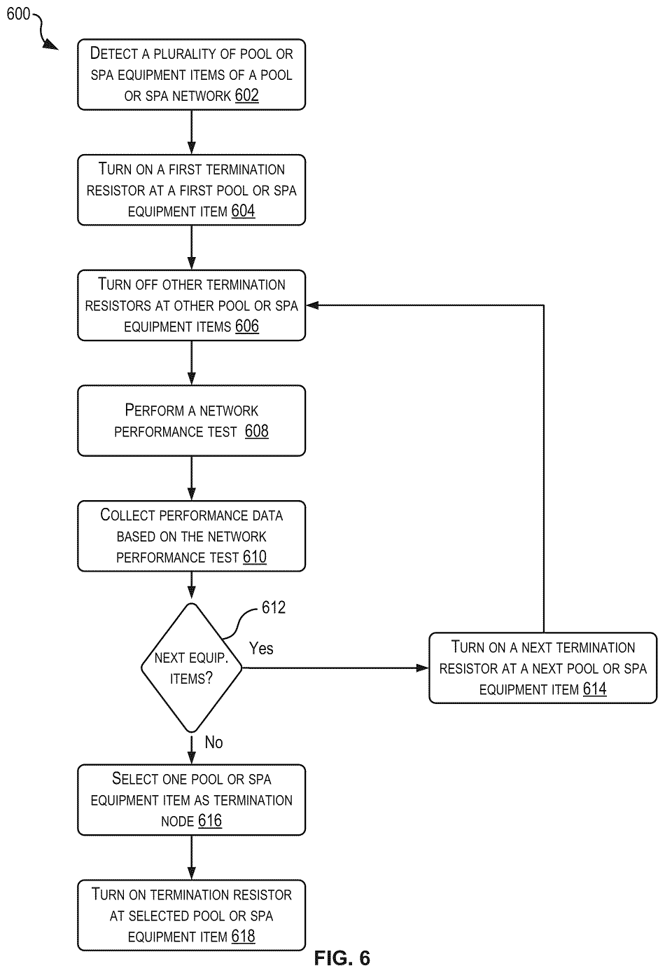

The same processes provided in the description of FIG. 3 may be implemented in the network illustrated in FIG. 4, as well as the processes described in FIG. 5 and FIG. 6.

### Example Flow Diagrams for Methods for Auto-Terminating a Network of Pool or Spa Equipment Items.

FIGS. 5, 6, 7, and 8 illustrate example flow diagrams showing processes 500, 600, 700, and 800. These processes, and any other processes described herein, are illustrated as a logical flow diagram, each operation of which represents a sequence of operations that can be implemented in hardware, computer instructions, or a combination thereof such as implemented in controller node 102 from FIG. 1, controller node 302 from FIG. 3, controller 402 from FIG. 4, and computer system 1000. In some examples, these processes may be triggered by a command from another device, such as a user device in communication with controller node 102 302 and controller 402, such as a smartphone or laptop, or may be automatically performed upon establishing a network or adding equipment to the network. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

FIG. 5 illustrates a flow diagram representing a process of automatically terminating a network of pool or spa equipment items. Process 500 begins at block 502 by detecting a plurality of pool or spa equipment items connected within a serial network. This block may include a controller, such as controller node 102, 302, and controller 402 from FIG. 1, FIG. 2, and FIG. 4, pinging one or more equipment items to identify that the equipment items are connected to the network. In further examples, the controller may reference a table of connected equipment items stored in memory. Other suitable approaches for identifying or otherwise looking up the equipment items connected to the pool or spa network may be used to detect the presence and addition of equipment items to the network, such as the controller measuring changes in impedance of the network, communications between the equipment items and the controller such as through Bluetooth, WiFi, and cellular or radio-frequency signals. In some examples, a user may provide input to the controller or a user device (e.g., cell phone, laptop, tablet) to notify the controller which equipment items are connected to the network and update the reference table.

At block 504, the process 500 includes conducting a first termination test using a first termination resistor. The first termination resistor may be associated with a first pool or spa equipment item from the plurality of pool or spa equipment items. In some examples, the first termination resistor may be part of the first pool or spa equipment item, part of a separate circuit, or part of the bus connecting the plurality of pool or spa equipment items and the controller. Termination tests may include various operations such as switching on one of the first termination resistor and the second termination resistor; testing a data rate of communication between the controller and one of the first pool or spa equipment item and the second pool or spa equipment item; and switching off one of the first termination resistor and the second termination resistor. For example, conducting the first termination test may include activating, by the controller, the first termination resistor, turning off termination resistors associated with other pool or spa equipment items from the plurality of pool or spa equipment items, and testing data rates of communications between the controller and pool or spa equipment items of the network, such as the data rate of communication between the controller and the first pool or spa equipment item. Conducting the termination test may further include collecting performance data from the termination test, such as the data rate of communication between the controller and the pool or spa equipment item associated with the active termination resistor.

At block 506, the process 500 includes conducting a second termination test using a second termination resistor. The second termination resistor may be associated with a second pool or spa equipment item from the plurality of pool or spa equipment items. The second termination test may include one or more operations described as operations performed in the first termination test. For example, conducting the second termination test may include activating, by the controller, the second termination resistor, turning off termination resistors associated with other pool or spa equipment items from the plurality of pool or spa equipment items, and testing data rates of communications between the controller and pool or spa equipment items of the network, such as the data rate of communication between the controller and the second pool or spa equipment item.

At block 508, process 500 includes instructing the first pool or spa equipment item to activate (e.g., turn on) the first termination resistor based in part on a comparison of the performance data collected from the first termination test and the second termination test. For example, the controller may determine which termination resistor to activate based on a comparison of performance data such as the data rate of communication between the controller and the plurality of pool or spa items. In some examples, the controller may turn on the termination resistor at the pool or spa equipment item associated with the termination test resulting in the highest data rate of communication between the controller and the pool or spa equipment items.

FIG. 6 illustrates a further example of a process of automatically terminating a network of pool or spa equipment items. Process 600 begins at block 602 by detecting a plurality of pool or spa equipment items of a pool or spa network. This block may include a controller, such as controller node 102, 302, and controller 402 from FIG. 1, FIG. 2, and FIG. 4, pinging each equipment item, referencing a table of connected equipment items stored in memory, or performing any other suitable approach for identifying or otherwise looking up the equipment items connected to the pool or spa network.

At block 604, the process 600 includes turning on a first termination resistor at a first pool or spa equipment item. This may include the automated controller sending a control signal to an agent terminating circuit and resistor (ATCR), at the first pool or spa equipment item, which causes the ATCR to turn on, switch in, or otherwise cause the first termination resistor to be connected to the network at the first pool or spa equipment item.

In some examples, the ATCR is part of pool or spa equipment items, such as an initial circuit where a bus connects to the pool or spa equipment items. In other examples, the ATCR is a separate circuit located at the pool or spa equipment items either between the pool or spa equipment item, or in parallel with the pool or spa equipment items, as shown in FIG. 1.

At block 606, the process 600 includes turning off other termination resistors at other pool or spa equipment items that are not the first spa or pool equipment item. This may be performed similarly as described with respect to block 604 for turning on the first termination resistors. In some examples, the other termination resistors may include all other termination resistors in the network, other than the termination resistor at the automated controller and the termination resistor at the first spa or pool equipment item.

At block 608, the process 600 includes performing a network performance test, such as a network speed test. This may include the automated controller executing a performance test by increasing data rates on the network, while monitoring data packet error to identify a network data rate when a given termination resistor is turned on. In some examples, the performance test also tests the accuracy of data sent by the automated controller and messages returned by pool and spa equipment to evaluate the accuracy of the network and to identify distortions or integrity issues of the network, as well as where distortions or integrity issues of the network are occurring.

At block 610, the process 600 includes collecting performance data based on the network performance test, such as the network speed test. The results of the network performance test, along with the particular configuration of the termination resistors in the network, may be logged. For example, a maximum speed, a binary value for each termination resistor (e.g., on or off), and an association between the binary value and the specific termination resistor/pool or spa equipment item may be recorded in a table. In some examples, additional information from the performance data may be recorded in the table, such as issues regarding distortions or network integrity issues.

At block 612, the process 600 includes determining whether a next pool or spa equipment item exists to be tested. For example, as the network may include multiple pool or spa equipment items, the process 600 may be iteratively repeated to test each item as “the termination node” for the network. If the answer at 612 is “yes,” the process continues to block 614. At block 614, the process 600 includes turning on a next termination resistor at a next pool or spa equipment item. This block may be performed similarly to block 604.

In some examples, the automated controller may iteratively and systematically perform each test starting with pool and spa equipment farthest away from the automated controller, and iteratively performing the test for each item of pool and spa equipment that is next farthest away, and so on until performing the test for the item of pool and spa equipment closest to the automated controller. In other examples, the automated controller may begin with the closest item of pool and spa equipment and iteratively perform the test on items of pool and spa equipment as they are farther and farther away from the automated controller. In further examples, the automated controller may implement a preset algorithm to determine which item of pool equipment to perform tests on in a particular order.

After block 614, the process 600 returns to block 606, at which other termination resistors, including the first termination resistor, are turned off. Next, a new network speed test is performed at block 608 using the next termination resistor turned on and all other termination resistors turned off. At block 610, the performance data associated with this new network speed test is recorded. And at block 612 it is again determined whether there is another next pool or spa equipment item for evaluation. If no, the process 600 proceeds to block 616. At block 616, the process 600 includes selecting one pool or spa equipment item as the termination node. This may be based on the performance data collected iteratively between blocks 604 and 614 for the different equipment items. In some examples, block 616 may include selecting the configuration that produced the highest data rates, which may be indicative of that pool or spa equipment item being the furthest from the automated controller.

At block 618, the process 600 includes turning on the termination resistor at the selected pool or spa equipment item. For example, this may include configuring the network as identified at block 616. The termination resistors at the remaining non-selected pool or spa equipment items will be turned off at this point. This may result in the maximum data rate for the network.

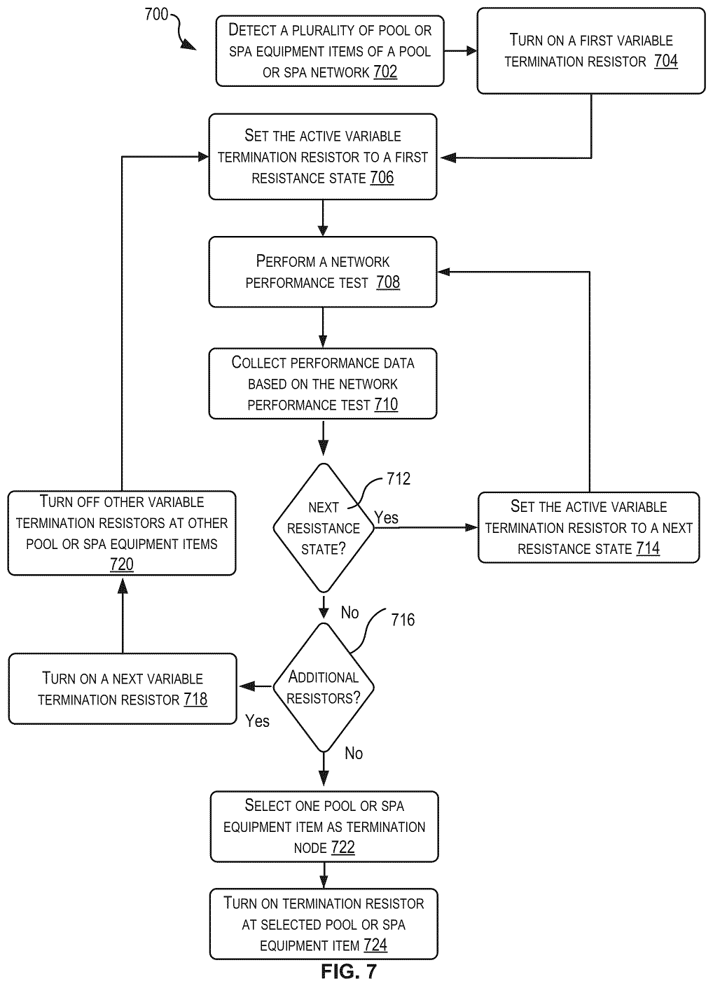

In some examples, the process 600 may be repeated periodically, when certain conditions occur, or based on any other suitable trigger. For example, when a new pool or spa equipment item is added to the network, the process 600 may be repeated to confirm/identify an optimal configuration for termination resistors. In some examples, each termination resistor has a variable impedance, and the system may choose to dynamically change the termination resistance, as further described in the description of FIG. 7. In some examples, the system can choose to terminate more than the typical two nodes by having multiple terminations with different termination resistances. The table of performance data may include multiple columns indicating whether a given termination resistor is activated for items of pool equipment to accommodate for networks with multiple termination resistors at items of pool equipment.

### Example Flow Diagram of a Method for Auto-Terminating a Network of Pool or Spa Equipment Using Variable Termination Resistors

FIG. 7 illustrates a flow diagram for auto-terminating network devices using variable termination resistors according to process 700. In some examples, steps of process 700 may not be executed or executed in different sequences, such as in networks having a plurality of pool and spa equipment where one or more items of pool and spa equipment do not have a variable termination resistor while other items include a variable termination resistor.

The process 700 begins at block 702 by detecting a plurality of pool or spa equipment items of a pool or spa network. As provided in the description of FIG. 6, an automated controller, such as controller node 102 302 and controller 402 from FIG. 1, FIG. 2, and FIG. 4, may detect the plurality of pool or spa equipment items by pinging each equipment item, referencing a table of connected equipment items stored in memory, or performing any other suitable approach for identifying or otherwise looking up the equipment items connected to the pool or spa network.

At block 704, the process 700 includes turning on a first variable termination resistor at a first pool or spa equipment item. This may include the automated controller sending a control signal to an agent terminating circuit at the first pool or spa equipment item, which causes the agent terminating circuit to turn on, switch in, or otherwise cause the first variable termination resistor to be connected to the network at the first pool or spa equipment item.

At block 706, the process 700 includes setting the active variable termination resistor (e.g., the variable termination resistor currently turned on) to a first resistance state. For example, the automated controller may communicate with an agent terminating circuit of at a pool or spa item to adjust resistance values (e.g., the resistance state) of the variable termination resistor.

At block 708, the process 700 includes performing a network performance test. As discussed in the description of FIG. 6, this may include the automated controller executing a performance test by increasing data rates on the network, while monitoring data packet error to identify a network data rate when a given termination resistor is turned on.

At block 710, the process 700 includes collecting performance data based on the network performance test. The results of the network performance test, along with the configuration of the variable termination resistors in the network, may be logged by the automated controller. For example, a maximum speed (e.g., data rate), a binary value for each termination resistor (e.g., on or off), and an association between the binary value and the specific termination resistor/pool or spa equipment item may be recorded in a table. In some examples, additional information from the performance data may be recorded in the table, such as issues regarding distortions or network integrity issues.

At block 712, the process 700 includes determining whether to adjust the variable termination resistor to a next resistance state. In some examples, the automated controller may adjust the resistance of variable resistors to a preset number of states, such as five separate resistance states of equal or varying differences in resistance (e.g., state 1: 100 ohms, state 2: 200 ohms, state 3: 300 ohms), or the variable termination resistor may be configured to have a finite number of states which the automated controller iterates through.

When the automated controller determines to test a next resistance state, the process continues to block 714 which sets the active variable termination resistor to a next resistance state, such as by using the same or similar techniques used in block 706. The automated controller may then perform a network performance test according to block 708 and collect the performance data based on the network performance test according to block 710. The process may repeat this loop for a next resistance state until the automated controller determines not to advance to the next resistance state in block 714, such as when the automated controller has collected performance data for a predetermined number of resistance states.

When the automated controller determines not to advance the active variable termination resistor to a next resistance state, process 700 may proceed to block 716 where the automated controller may determine whether to activate a next variable termination resistor. When the automated controller determines to activate (e.g., turn on) the next variable termination resistor, process 700 may proceed to block 718 which includes turning on a next variable termination resistor. The process 700 further includes block 720 to turn off other variable termination resistors at other pool or spa equipment. In some examples, block 718 and block 720 may be performed concurrently or in a separate order.

Process 700 may proceed to block 706 to set the active termination resistor to a first resistance state and proceed through blocks 708-716. When the automated controller determines not to turn on a next variable termination resistor, process 700 may proceed to block 722. At block 722, the process 700 includes selecting one pool or spa equipment item as the termination node. This may be based on the performance data collected iteratively between blocks 706 and 714 for the different equipment items at different resistances. In some examples, block 722 may include selecting the configuration that produced the highest data rates, which may be indicative of that pool or spa equipment item being the furthest from the automated controller.

At block 724 the process 700 includes turning on the variable termination resistor at the selected pool or spa equipment item to a determined resistance state. For example, this may include configuring the network as identified at block 722. The variable termination resistors at the remaining non-selected pool or spa equipment items will be turned off at this point. This may result in the maximum data rate for the network.

### Example Flow Diagram of Terminating a Network By Activating Multiple Termination Resistors

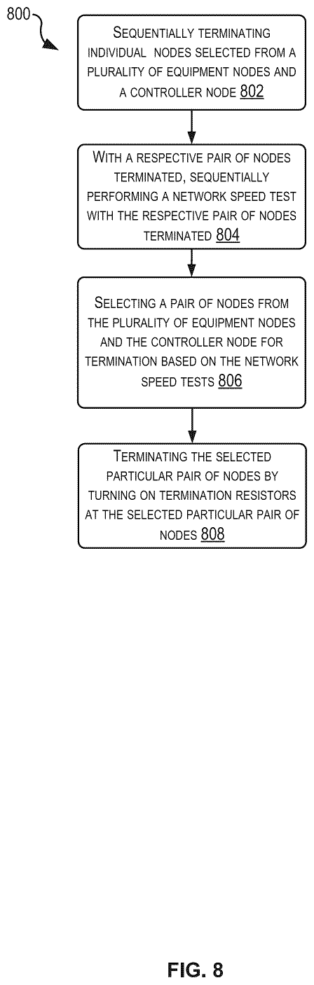

FIG. 8 illustrates a flow diagram for auto-terminating a network using multiple termination resistors according to process 800. The process 800 begins at block 802 by sequentially terminating individual nodes selected from a plurality of pool or spa equipment nodes and a controller node. For example, in a network with three pool or spa equipment nodes, the process may sequentially terminate the first pool or spa equipment node, the second pool or spa equipment node, the third pool or spa equipment node, and combinations of the pool or spa equipment nodes such as the first and second, the first and third, and the second and third.

At block 804, the process 800 includes sequentially performing a network speed test with pairs of terminated pool or spa equipment nodes. For example, the controller node may perform a network speed test to test the data rate of communication between nodes of the network when the first and second pool or spa equipment nodes are terminated, when the first and third pool or spa equipment nodes are terminated, and when the second and third pool or spa equipment nodes are terminated.

At block 806, the process 800 includes selecting a pair of nodes from the plurality of equipment nodes and the controller node for termination based on the network speed tests. For example, when the network speed tests indicate a higher data rate of communication within the network when the first and second pool or spa equipment nodes are terminated, the controller node may select the first and second pool or spa equipment nodes for termination.

At block 808, process 800 includes terminating the selected pair of pool or spa equipment nodes by turning on termination resistors at the selected pair of pool or spa equipment nodes. For example, the process 800 may use techniques for turning on termination resistors as further described in the description for FIG. 1 and FIG. 3, as well as any other techniques for turning on and activating termination resistors described herein.

### Example Method of Dynamic Drive Current Adjustment

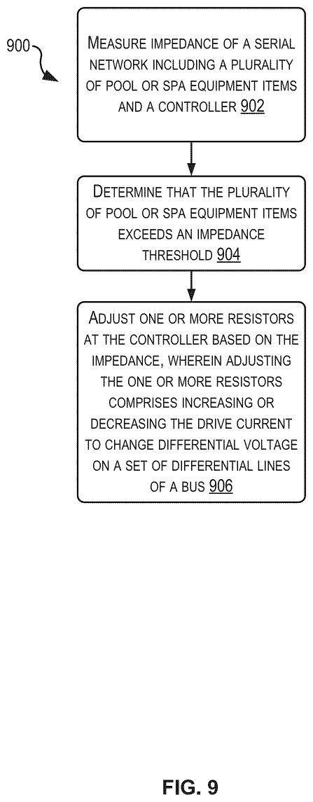

FIG. 9 illustrates an example flow diagram showing process 900 for dynamic current adjustment of a controller connected to a serial network of pool and spa equipment items by a bus, such as the bus further described in the description of FIG. 1. This process, and any other processes described herein, are illustrated as a logical flow diagram, each operation of which represents a sequence of operations that can be implemented in hardware, computer instructions, or a combination thereof such as implemented in controller node 102 from FIG. 1, controller node 302 from FIG. 3, controller 402 from FIG. 4, and computer system 1000. The order in which the operations are described is not intended to be construed as a limitation, and any number of the described operations can be combined in any order and/or in parallel to implement the processes.

Process 900 may begin at block 902 which includes measuring impedance of a serial network including a plurality of pool or spa equipment. A controller, such as the controller node described in the description of FIG. 1, FIG. 3, and FIG. 4 may measure the impedance of the serial network by measuring the voltage and current across a bus, such as an RS-485 bus between pool or spa equipment items connected to the network and the controller connected to the network. In further examples, the controller may be equipped with an ohmmeter for measuring an overall impedance of the serial network, or the impedance of various pool or spa equipment items connected to the serial network.

In further examples, the controller may calculate impedance from known loads associated with the pool or spa equipment items connected to the network. For example, agent terminating circuits and resistors (ATCR) associated with the pool or spa equipment items may each be rated with a particular unit load, and the controller may calculate the impedance of the network from the rated unit loads.

At block 904, process 900 may include determining that the plurality of pool or spa equipment items exceeds an impedance threshold. The impedance threshold may be preset by the controller. When the plurality of pool or spa equipment items exceeds the impedance threshold, process 900 may include block 906. At block 906, the controller may adjust one or more termination resistors at the controller based on the measured or calculated impedance of the serial network. By adjusting the one or more termination resistors at the controller, the controller may increase or decrease a drive current from the controller to the serial network. By adjusting the drive currents, the controller may adjust differential voltage of differential lines on the bus connecting the controller to the plurality of pool or spa equipment items.

### Example Computer System for Auto-Terminating Network Devices

FIG. 10 illustrates examples of components of a computer system 1000, according to at least one example. The computer system 1000 is an example of controllers and/or microcontrollers of pool equipment and/or pool automation systems including automation controllers, and the like.

The computer system 1000 may include at least a processor 1002, a memory 1004, a storage device 1006, input/output peripherals (I/O) 1008, communication peripherals 1010, and an interface bus 1012. The interface bus 1012 is configured to communicate, transmit, and transfer data, controls, and commands among the various components of the computer system 1000. The memory 1004 and the storage device 1006 include computer-readable storage media, such as Radom Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. The memory 1004 and the storage device 1006 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 1000.

Further, the memory 1004 may include an operating system, programs, and applications. The processor 1002 is configured to execute the stored instructions and includes, for example, a logical processing unit, a microprocessor, a digital signal processor, and other processors. The memory 1004 and/or the processor 1002 can be virtualized and can be hosted within another computing system of, for example, a cloud network or a data center. The I/O peripherals 1008 may include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 1008 are connected to the processor 1002 through any of the ports coupled to the interface bus 1012. The communication peripherals 1010 are configured to facilitate communication between the computer system 1000 and other computing devices over a communications network and include, for example, a network interface controller, modem, wireless and wired interface cards, antenna, and other communication peripherals.

### Example Embodiments

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

A collection of exemplary embodiments, including at least some explicitly enumerated as “Examples” providing additional description of a variety of example types in accordance with the concepts described herein are provided below. These examples are not meant to be mutually exclusive, exhaustive, or restrictive; and are not limited to these examples but rather encompasses all possible modifications and variations within the scope of the issued claims and their equivalents.

Example 1: A method for automatically terminating a serial network of pool or spa equipment items, comprising: conducting a first termination test using a first termination resistor associated with a first pool or spa equipment item of a plurality of pool or spa equipment items; conducting a second termination test using a second termination resistor associated with a second pool or spa equipment item of the plurality of pool or spa equipment items; and instructing the first pool or spa equipment item to turn on the first termination resistor based at least in part on a comparison of first performance data associated with the first termination test and second performance data associated with the second termination test, wherein turning on the first termination resistor terminates the first pool or spa equipment item.

Example 2: The method of any of the preceding or subsequent examples or combination of examples, wherein the plurality of pool or spa equipment items includes one or more of: a water treatment device, a water heater, lighting, a filtration system, water pumps, and a pool cover.

Example 3: The method of any of the preceding or subsequent examples or combination of examples, wherein the first termination resistor and the second termination resistor are variable resistors with multiple impedance states, and the method further comprises: performing network performance tests for multiple impedance states of the first termination resistor and the second termination resistor.

Example 4: The method of any of the preceding or subsequent examples or combination of examples, further comprising: detecting a third pool or spa equipment item added to the plurality of pool or spa equipment items and the network; conducting a third termination test using a third termination resistor associated with the third pool or spa equipment item of the plurality of pool or spa equipment items; and instructing the third pool or spa equipment item to turn on the first termination resistor based at least in part on a comparison of third performance data associated with the third termination test with the first performance data and the second performance data.

Example 5: The method of any of the preceding or subsequent examples or combination of examples, wherein the method further comprises: measuring, by the controller, impedance characteristics of the network; determining that the impedance characteristics exceed a predetermined threshold for the network; and adjusting an impedance state of one or more of the first termination resistor, the second termination resistor, or a termination resistor associated with the controller based on the impedance characteristics of the network.

Example 6: The method of any of the preceding or subsequent examples or combination of examples, wherein adjusting the impedance state of one or more of the first termination resistor and the second termination resistor comprises either: decreasing or increasing a drive current of the controller to change differential voltage on a set of differential lines of a bus.

Example 7: The method of any of the preceding or subsequent examples or combination of examples, wherein the bus is a RS-485 bus connecting the plurality of network pool or spa equipment items and the controller.

Example 8: The method of any of the preceding or subsequent examples or combination of examples, further comprising: detecting, by a controller, the plurality of pool or spa equipment items connected within the serial network, wherein detecting includes pinging the plurality of pool or spa equipment within the serial network or referencing a table of pool or spa equipment items connected to the controller.

Example 9: The method of any of the preceding or subsequent examples or combination of examples, wherein conducting the first termination test and the second termination test includes: switching on one of the first termination resistor and the second termination resistor; testing a data rate of communication between the controller and one of the first pool or spa equipment item and the second pool or spa equipment item; and switching off one of the first termination resistor and the second termination resistor

Example 10: The method of any of the preceding or subsequent examples or combination of examples, further comprising: recording the first performance data and the second performance data in a reference table; and identifying the pool or spa equipment items to terminate based on the data rate.

Example 11: The method of any of the preceding or subsequent examples or combination of examples, further comprising: setting the data rate of communication between the controller and the plurality of network devices based on the higher of the data rates from comparing the performance data.

Example 12: A controller for automatically terminating a serial network of pool or spa equipment items comprising: a non-transitory computer-readable medium storing computer-executable program instructions; and a processor communicatively coupled to the non-transitory computer-readable medium for executing the computer-executable program instructions, wherein executing the computer-executable program instructions configures the processor to perform operations comprising: conduct a first termination test using a first termination resistor associated with a first pool or spa equipment item of a plurality of pool or spa equipment items; conduct a second termination test using a second termination resistor associated with a second pool or spa equipment item of the plurality of pool or spa equipment items; and instruct the first pool or spa equipment item to turn on the first termination resistor based at least in part on a comparison of first performance data associated with the first termination test and second performance data associated with the second termination test, wherein turning on the first termination resistor terminates the first pool or spa equipment item.

Example 13: The controller of any of the preceding or subsequent examples or combination of examples, wherein the termination resistors are variable resistors with multiple impedance states, and the controller is further configured to perform network performance tests for multiple impedance states of termination resistors when switched on.

Example 14: The controller of any of the preceding or subsequent examples or combination of examples, wherein the first termination resistor and the second termination resistor are variable resistors with multiple impedance states, and the processor is further configured to: perform network performance tests for multiple impedance states of the first termination resistor and the second termination resistor

Example 15: The controller of any of the preceding or subsequent examples or combination of examples, wherein the processor is further configured to: detect a third pool or spa equipment item added to the plurality of pool or spa equipment items and the network; conduct a third termination test using a third termination resistor associated with the third pool or spa equipment item of the plurality of pool or spa equipment items; and instructing the third pool or spa equipment item to turn on the first termination resistor based at least in part on a comparison of third performance data associated with the third termination test with the first performance data and the second performance data.

Example 16: The controller of any of the preceding or subsequent examples or combination of examples, wherein the processor is further configured to: measure, by the controller, impedance characteristics of the network; determine that the impedance characteristics exceed a predetermined threshold for the network; and adjust an impedance state of one or more of the first termination resistor, the second termination resistor, or a termination resistor associated with the controller based on the impedance characteristics of the network.

Example 17: The controller of any of the preceding or subsequent examples or combination of examples, wherein adjusting the impedance state of one or more of the first termination resistor and the second termination resistor comprises either: decreasing or increasing a drive current of the controller to change differential voltage on a set of differential lines of a bus.

Example 18: The controller of any of the preceding or subsequent examples or combination of examples, wherein the conducting the first termination test and the second termination test includes: switching on one of the first termination resistor and the second termination resistor; testing a data rate of communication between the controller and one of the first pool or spa equipment item and the second pool or spa equipment item; and switching off one of the first termination resistor and the second termination resistor.

Example 19: The controller of any of the preceding or subsequent examples or combination of examples, wherein the processor performs operations further comprising: recording the first performance data and the second performance data in a reference table, and wherein the controller identifies the network device from the plurality of pool or spa equipment items to terminate based on the data rate.

Example 20: A system for automatically terminating a network device from a serial network comprising: a controller comprising a non-transitory computer-readable medium storing computer-executable program instructions and a processor communicatively coupled to the non-transitory computer-readable medium for executing the computer-executable program instructions; a plurality of pool and spa equipment configured to form the serial network with the controller; and wherein executing the computer-executable program instructions configures the processor to perform operations comprising: conduct a first termination test using a first termination resistor associated with a first pool or spa equipment item of a plurality of pool or spa equipment items; conduct a second termination test using a second termination resistor associated with a second pool or spa equipment item of the plurality of pool or spa equipment items; and instruct the first pool or spa equipment item to turn on the first termination resistor based at least in part on a comparison of first performance data associated with the first termination test and second performance data associated with the second termination test, wherein turning on the first termination resistor terminates the first pool or spa equipment item.

Example 21: A controller for dynamically adjusting a drive current in an controller, the controller comprising: a non-transitory computer-readable medium storing computer-executable program instructions; and a processor communicatively coupled to the non-transitory computer-readable medium for executing the computer-executable program instructions, wherein executing the computer-executable program instructions configures the processor to perform operations comprising: measure impedance of a serial network comprised of a plurality of pool and spa equipment items and the controller; determine that the plurality of pool and spa equipment items exceeds an impedance threshold; adjust one or more resistors at the controller based on the impedance, wherein adjusting the one or more resistors comprises increasing or decreasing the drive current to change differential voltage on a set of differential lines of a bus.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present embodiments are not limited to the embodiments described above or depicted in the drawings, and various embodiments and modifications may be made without departing from the scope of the claims below.

For avoidance of doubt, any combination of features not physically impossible or expressly identified as non-combinable herein may be within the scope of the described embodiments. Further, although applicant has described devices and techniques for use principally with automated controllers, persons skilled in the relevant field will recognize that the present disclosure conceivably could be employed in connection with other objects and in other manners. Finally, references to “pools” and “swimming pools” herein may also refer to spas or other water containing vessels used for recreation or therapy and for which control is needed or desired.

What is claimed is:

1. A method for automatically terminating a network of pool or spa equipment items, comprising:
conducting a first termination test using a first termination resistor associated with a first pool or spa equipment item of a plurality of pool or spa equipment items;
conducting a second termination test using a second termination resistor associated with a second pool or spa equipment item of the plurality of pool or spa equipment items; and
instructing the first pool or spa equipment item to turn on the first termination resistor based at least in part on a comparison of first performance data associated with the first termination test and second performance data associated with the second termination test, wherein turning on the first termination resistor terminates the first pool or spa equipment item.

2. The method of claim 1, wherein the plurality of pool or spa equipment items includes one or more of: a water treatment device, a water heater, lighting, a filtration system, water pumps, and a pool cover.

3. The method of claim 1, wherein the first termination resistor and the second termination resistor are variable resistors with multiple impedance states, and the method further comprises:
performing network performance tests for multiple impedance states of the first termination resistor and the second termination resistor.

4. The method of claim 1, further comprising:
detecting a third pool or spa equipment item added to the plurality of pool or spa equipment items and the network;
conducting a third termination test using a third termination resistor associated with the third pool or spa equipment item of the plurality of pool or spa equipment items; and
instructing the third pool or spa equipment item to turn on the first termination resistor based at least in part on a comparison of third performance data associated with the third termination test with the first performance data and the second performance data.

5. The method of claim 3, further comprising:
measuring, by a controller, impedance characteristics of the network;
determining that the impedance characteristics exceed a predetermined threshold for the network; and
adjusting an impedance state of one or more of the first termination resistor, the second termination resistor, or a termination resistor associated with the controller based on the impedance characteristics of the network.

6. The method of claim 5, wherein adjusting the impedance state of one or more of the first termination resistor and the second termination resistor comprises either:
decreasing or increasing a drive current of the controller to change differential voltage on a set of differential lines of a bus.

7. The method of claim 1, wherein the network connects the pool or spa equipment items and a controller by an RS-485 bus.

8. The method of claim 1, further comprising:
detecting, by a controller, the plurality of pool or spa equipment items connected within the network, wherein detecting includes pinging the plurality of pool or spa equipment within the network or referencing a table of pool or spa equipment items connected to the controller.

9. The method of claim 1, wherein the conducting the first termination test and the second termination test includes:
switching on one of the first termination resistor and the second termination resistor;
testing a data rate of communication between a controller and one of the first pool or spa equipment item and the second pool or spa equipment item; and
switching off one of the first termination resistor and the second termination resistor.

10. The method of claim 9, further comprising:
recording the first performance data and the second performance data in a reference table; and
identifying the pool or spa equipment items to terminate based on the data rate.

11. The method of claim 9, further comprising:
setting the data rate of communication between the controller and pool or spa equipment items based on the higher of the data rates from comparing the first and second performance data.

12. A controller for automatically terminating a serial network of pool or spa equipment items, comprising:
a non-transitory computer-readable medium storing computer-executable program instructions; and
a processor communicatively coupled to the non-transitory computer-readable medium for executing the computer-executable program instructions, wherein executing the computer-executable program instructions configures the processor to perform operations comprising:
conduct a first termination test using a first termination resistor associated with a first pool or spa equipment item of a plurality of pool or spa equipment items;
conduct a second termination test using a second termination resistor associated with a second pool or spa equipment item of the plurality of pool or spa equipment items; and
instruct the first pool or spa equipment item to turn on the first termination resistor based at least in part on a comparison of first performance data associated with the first termination test and second performance data associated with the second termination test, wherein turning on the first termination resistor configures the first termination resistor to terminate the first pool or spa equipment item.

13. The controller of claim 12, wherein the first and second termination resistors are variable resistors with multiple impedance states, and the controller is further configured to perform network performance tests for multiple impedance states of the first and second termination resistors when switched on.

14. The controller of claim 12, wherein the first termination resistor and the second termination resistor are variable resistors with multiple impedance states, and the processor is further configured to:
perform network performance tests for multiple impedance states of the first termination resistor and the second termination resistor.

15. The controller of claim 12, wherein the processor is further configured to:
detect a third pool or spa equipment item added to the plurality of pool or spa equipment items and the network;
conduct a third termination test using a third termination resistor associated with the third pool or spa equipment item of the plurality of pool or spa equipment items; and
instruct the third pool or spa equipment item to turn on the first termination resistor based at least in part on a comparison of third performance data associated with the third termination test with the first performance data and the second performance data.

16. The controller of claim 14, wherein the processor is further configured to:
measure, by the controller, impedance characteristics of the network;
determine that the impedance characteristics exceed a predetermined threshold for the network; and
adjust an impedance state of one or more of the first termination resistor, the second termination resistor, or a termination resistor associated with the controller based on the impedance characteristics of the network.

17. The controller of claim 16, wherein adjusting the impedance state of one or more of the first termination resistor and the second termination resistor comprises either:
decreasing or increasing a drive current of the controller to change differential voltage on a set of differential lines of a bus.

18. The controller of claim 12, wherein conducting the first termination test and the second termination test includes:
switching on one of the first termination resistor and the second termination resistor;
testing a data rate of communication between the controller and one of the first pool or spa equipment item and the second pool or spa equipment item; and
switching off one of the first termination resistor and the second termination resistor.

19. The controller of claim 18, wherein the processor is further configured to:
record the first performance data and the second performance data in a reference table, and wherein the controller identifies the pool or spa equipment items to terminate based on the data rate.

20. A system for automatically terminating a network device from a serial network comprising:
a controller comprising a non-transitory computer-readable medium storing computer-executable program instructions and a processor communicatively coupled to the non-transitory computer-readable medium for executing the computer-executable program instructions;
a plurality of pool and spa equipment configured to form the serial network with the controller; and
wherein executing the computer-executable program instructions configures the processor to perform operations comprising:
conduct a first termination test using a first termination resistor associated with a first pool or spa equipment item of a plurality of pool or spa equipment items;
conduct a second termination test using a second termination resistor associated with a second pool or spa equipment item of the plurality of pool or spa equipment items; and
instruct the first pool or spa equipment item to turn on the first termination resistor based at least in part on a comparison of first performance data associated with the first termination test and second performance data associated with the second termination test, wherein turning on the first termination resistor terminates the first pool or spa equipment item.

21. A controller for dynamically adjusting a drive current, the controller comprising:
a non-transitory computer-readable medium storing computer-executable program instructions; and
a processor communicatively coupled to the non-transitory computer-readable medium for executing the computer-executable program instructions, wherein executing the computer-executable program instructions configures the processor to perform operations comprising:
measure impedance of a serial network comprised of a plurality of pool and spa equipment items and the controller;
determine that the plurality of pool and spa equipment items exceeds an impedance threshold; and
adjust one or more resistors at the controller based on the impedance, wherein adjusting the one or more resistors comprises increasing or decreasing the drive current to change differential voltage on a set of differential lines of a bus.
